(19) United States
(12) Patent Application Publication
(10) Pub. No.: US 2025/0076203 A1
(43) Pub. Date: Mar. 6, 2025

(54) CAT LITTER AND CAT LITTER TOPPER

(71) Applicant: Paco van Meer, Austin, TX (US)

(72) Inventor: Paco van Meer, Austin, TX (US)

(21) Appl. No.: 18/240,352

(22) Filed: Aug. 31, 2023

(51) Int. Cl. G01N 21/78; A01K 1/015

(52) U.S. Cl. CPC G01N 21/78; A01K 1/0154

(57) ABSTRACT

According to an aspect of the present invention, there is provided a mixture for a cat litter or cat litter topper, comprising: pure silicate gel; water; and a pH indicator; wherein the mixture comprises micropores and microcapillaries.

### BACKGROUND

Although clay is a common cat litter ingredient, cat litter made from a variety of other materials is known, including sand, ashes, cinder, pine chips, wheat, walnut shells, corn cobs, sawdust, and paper. A variety of types of cat litter have been described in the patent literature.

The prior materials science art also discloses technology that aids in detection and diagnosis wherein the presence or characteristics of specific chemicals, cells, molecules, DNA, and the like triggers a change in color. The technology has been used for various purposes including medical diagnosis for animals as well as humans. According to the prior art, chemical agents are known that when interacting with another chemical compound can change to a specific color. This change in color can be used to detect a specified characteristic of the chemical compound being tested. The change in color can be in response to chemical compounds corresponding to a medical condition in a human or an animal including a companion animal.

In recent years, technology has even been disclosed for cat litter that can be used to diagnose veterinary conditions affecting a cat. For example, cat litter can comprise a chemical that changes in color when it comes in contact with waste products of a cat. One color could indicate healthy waste products and other colors could indicate potential illness in the cat. The owner of the cat could then be alerted to take the cat to a veterinary doctor for further workup.

Nevertheless, prior art technology is disadvantageous in many ways including at least in terms of cost, accuracy, ease of use, and suitability for use in combination with functional elements other than indicating a health condition.

### SUMMARY OF INVENTION

Accordingly, the present invention provides an improved cat litter and cat litter topper.

According to an aspect of the present invention, there is provided a mixture for a cat litter or cat litter topper, comprising: pure silicate gel; water; and a pH indicator; wherein the mixture comprises micropores and microcapillaries.

According to another aspect of the present invention, there is provided a process of manufacturing a cat litter or cat litter topper, comprising: combining pure silicate gel and water into a mixture; heating the mixture slowly at high pressure for approximately 36 hours; and adding a pH indicator compound; wherein micropores and microcapillaries are created during the heating of the mixture.

### BRIEF DESCRIPTION OF THE DRAWINGS

FIG. 1 shows a color scale for a health-indicating cat litter and cat litter topper according to an embodiment of the present invention;

FIG. 2 shows a cat litter box containing litter according to an embodiment of the present invention; and

FIG. 3 illustrates a cat litter topper according to an embodiment of the present invention.

### DETAILED DESCRIPTION

Older cats in particular are prone to suffer from urinary issues, including struvite stones. Many other health problems also affect cats of all ages. Often cat owners only recognizes the symptoms if owners themselves notice that the cat shows symptoms of disease, but frequently conditions can go on for some time without the owner's notice, while the cat is in extreme pain.

Solutions for early detection of diseases in cat can be implemented in cat litter itself or “topper” material which can be added to cat litter. Either the litter or the litter topper can contain compounds that change color in reaction to cat urine or feces. A color chart can be provided to help an owner interpret the color change.

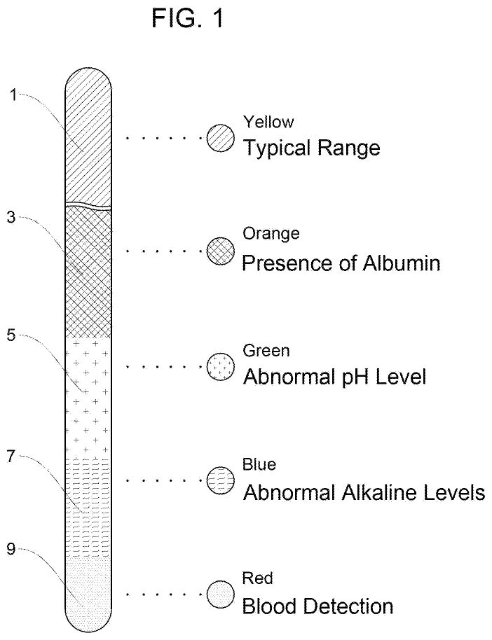

FIG. 1 shows a color scale for a health-indicating cat litter and cat litter topper according to an embodiment of the present invention.

Sample 1 is reacted with the litter and turns a color, in this example yellow, which indicates a probable lack of disease. The change of color in response to a normal urine acts as a control to demonstrate that the test sample has been properly processed.

Sample 3 is reacted with the litter and turns orange, which indicates the presence of albumin. Albumin is an important blood protein in cats but is not normally present in the urine of cats without disease. Albumin in cat urine often is associated with primary kidney disease but could also indicate inflammatory conditions (e.g., dental disease, chronic skin disease, bowel inflammation, etc.), infectious disease (e.g., feline leukemia virus, feline immunodeficiency virus), metabolic disorders (e.g., diabetes mellitus, hyperthyroidism, etc.), hypertension (high blood pressure), and/or cancer.

Sample 5 is reacted with the litter and turns green, which indicates an abnormal pH level. Cat urine must have a particular pH to maintain urinary tract health. Although the healthy range varies, generally from 6.2 to 6.7 can be considered normal. A pH above this range can lead to the growth of struvites (magnesium ammonium phosphate crystals). A pH lower than this range can cause the formation of calcium oxalate crystals.

Sample 7 is reacted with the litter and turns blue, which indicates abnormal alkaline levels. Cat urinary tract infections are the most frequent cause of abnormal alkaline levels. The bacteria causing the infection also causes increased alkaline levels.

Sample 9 is reacted with the litter and turns red, which indicates the presence of blood. Blood can be found in cat urine for multiple reasons, including from bacterial infection, general inflammation from stress, urinary tract infections, crystals in the urine, and interstitial cystitis.

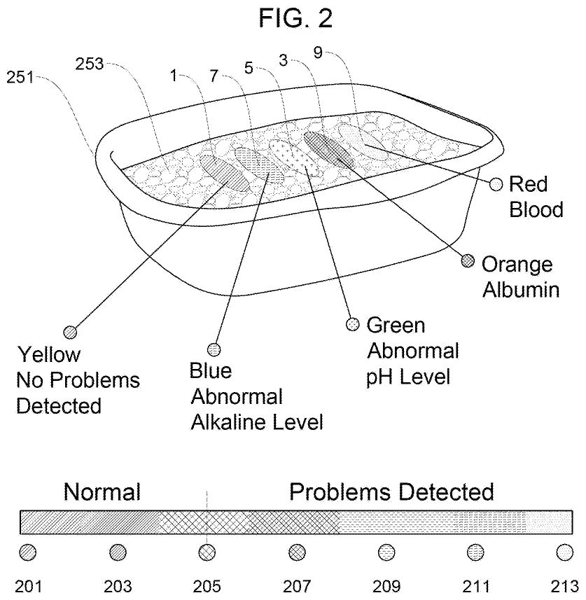

FIG. 2 shows a cat litter box containing litter according to an embodiment of the present invention.

Cat litter box 251 is a standard litter box commonly used by cats for urination and defecation. Cat litter box 251 is filled with cat litter 253. In this exemplary embodiment, samples of urine or feces from five different cats are added to the litter box.

Sample 1 is reacted with the litter and turns a color, in this example yellow, which indicates a probable lack of disease. The change of color in response to a normal urine acts as a control to demonstrate that the test sample has been properly processed.

Sample 3 is reacted with the litter and turns orange, which indicates the presence of albumin. Albumin is an important blood protein in cats but is not normally present in the urine of cats without disease. Albumin in cat urine often is associated with primary kidney disease but could also indicate inflammatory conditions (e.g., dental disease, chronic skin disease, bowel inflammation, etc.), infectious disease (e.g., feline leukemia virus, feline immunodeficiency virus), metabolic disorders (e.g., diabetes mellitus, hyperthyroidism, etc.), hypertension (high blood pressure), and/or cancer.

Sample 5 is reacted with the litter and turns green, which indicates an abnormal pH level. Cat urine must have a particular pH to maintain urinary tract health. Although the healthy range varies, generally from 6.2 to 6.7 can be considered normal. A pH above this range can lead to the growth of struvites (magnesium ammonium phosphate crystals). A pH lower than this range can cause the formation of calcium oxalate crystals.

Sample 7 is reacted with the litter and turns blue, which indicates abnormal alkaline levels. Cat urinary tract infections are the most frequent cause of abnormal alkaline levels. The bacteria causing the infection also causes increased alkaline levels.

Sample 9 is reacted with the litter and turns red, which indicates the presence of blood. Blood can be found in cat urine for multiple reasons, including from bacterial infection, general inflammation from stress, urinary tract infections, crystals in the urine, and interstitial cystitis.

A color scale can also be provided to determine whether a cat urine sample is normal or abnormal. Colors 201-213 are arranged on the scale, with colors 201 and 203 indicating a healthy urine sample an colors 205, 207, 209, 211, and 213 indicating a possible disease state.

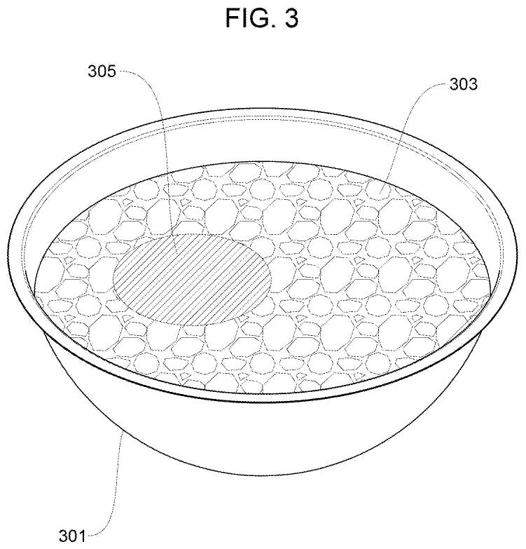

FIG. 3 illustrates a cat litter topper according to an embodiment of the present invention.

Cat litter topper embodiments can be added to existing cat litter for increased odor and moisture absorption, and/or for early detection of diseases according to the description above. Cat litter topper can be comprised of the same materials and made using the same process described above with respect to the exemplary cat litter embodiment disclosed as part of the present invention.

Container 301 is used to hold the cat litter topper. Container 301 can be original packaging or can be, for example, a dish belonging to a cat owner. Cat litter topper 303 shows the cat litter topper in an unused or unreacted state. Reacted cat litter topper 305 shows the cat litter topper after the animal has used it. Container 301 thus in this example could be a container holding cat litter topper which has already been used.

Both cat litter and cat litter topper according to embodiments comprises pure silicate gel, water, and a pH indicator; other embodiments comprise pure quartz sand, sodium and water. The mixture contains micropores and microcapillaries. The micropores and microcapillaries are formed by heating the mixture slowly at high pressure for approximately 36 hours.

Cat litter and cat litter topper according to embodiments are very efficient at pulling moisture out of the air. Embodiments can absorb or adsorb at least 130% of its own weight in moisture. This means that every 1,000 grams of cat litter or cat litter topper according to embodiments can absorb or adsorb at least 1300 ml of moisture.

What is claimed is:

1. A mixture for a cat litter or cat litter topper, comprising:
pure silicate gel;
water; and
a pH indicator,
wherein the mixture comprises micropores and microcapillaries.

2. The cat litter of claim 1, wherein the absorption ratio is at least 130% of the weight of the litter.

3. The cat litter of claim 1, further comprising an antibacterial compound.

4. The cat litter of claim 1, further comprising an anti stick compound configured so that the litter does not stick to the claws of the cat.

5. The cat litter of claim 1, further comprising sodium.

6. The cat litter of claim 1, further comprising a compound configured to indicate the presence of albumin.

7. The cat litter of claim 1, further comprising a compound configured to indicate the presence of blood.

8. A process of manufacturing a cat litter or cat litter topper, comprising:
combining pure silicate gel and water into a mixture;
heating the mixture slowly at high pressure for approximately 36 hours; and
adding a pH indicator compound;
wherein micropores and microcapillaries are created during the heating of the mixture.

9. The process of claim 8, further comprising adding sodium.

10. The process of claim 8, wherein the absorption ratio of the mixture is at least 130% of the weight of the litter.

11. The process of claim 8, further comprising adding an antibacterial compound.

12. The process of claim 8, further comprising adding a compound configured to indicate the presence of albumin.

13. The process of claim 8, further comprising adding a compound configured to indicate the presence of blood.
